(19) United States
(12) Patent Application Publication
(10) Pub. No.: US 2016/0031652 A1
(43) Pub. Date: Feb. 4, 2016

(54) FRUIT AND VEGETABLE TRANSPORT SYSTEM FOR A HARVESTING MACHINE AND HARVESTING MACHINE THAT INCLUDES SAID SYSTEM

(71) Applicant: Elisa ARGILÉS MAJÁ, (US)

(72) Inventor: Enric ARGILÉS VILALTA, Miralcamp (ES)

(73) Assignee: Elisa ARGILÉS MAJÁ, Valldoreix (ES)

(21) Appl. No.: 14/776,441

(22) PCT Filed: Mar. 17, 2014
(86) PCT No.: PCT/IB2014/059891

§ 371 Date: Sep. 14, 2015

(30) Foreign Application Priority Data
Mar. 15, 2013 (ES) P201330381

(51) Int. Cl. B65G 17/12; A01D 46/00

(52) U.S. Cl. CPC B65G 17/12; A01D 46/00

(57) ABSTRACT

Fruit and vegetable transport system for harvesting machine and harvesting machine that comprises a plurality of carrier units (2) for depositing a piece of fruit or vegetable in each one, said system (1) including means (8,9) for dragging said plurality of carrier units (2), said dragging means (8,9) determining a conveyor circuit that includes at least one section (6) for unloading said units (2) into a container, and at least one section (5) for loading the same units (2), once the fruit or vegetable has been deposited inside said container, wherein said dragging means comprise a chain (8) of links provided with means (9) for integrally joining said carrier units to said chain (8), each link (8a, 8b), of said chain (8) including the axis (13, 14) for a swivel joint with the adjacent links (8a, 8b), the axis (13, 14) of two adjacent link (8a, 8b) of said chain (8) determining a substantially right angle which allows the relative rotation of said links (8a, 8b) to guide said fruit or vegetable carrier units (2) in a predetermined place of the circuit. The machine (4) comprises a frame (3) provided with self-propulsion and travel means and the claimed transport system (1).

The present invention relates to a fruit and vegetable transport system for a harvesting machine and to a harvesting machine that includes said transport system.

### BACKGROUND OF THE INVENTION

The state of the art is familiar with fruit harvesting machines that present a frame mounted on wheels wherein the fruit transport system comprises means for conveying the fruit from the place of collection where an operative is located to a bulk container provided in the rear part of the machine.

Patent document ES2148060 discloses a machine for collecting fruit that includes a transport system of the type described. This machine is provided with a series of horizontal side platforms that can move in a sense that is transversal to the direction of the machine so as to adapt to the width of the terrain. Said platforms are disposed in such a way that they define different levels of collection and are provided with a support structure for the operatives who collect the fruit directly from the tree.

The fruit conveying means of the machine of this patent document include a series of side arms which are mounted in a rotary manner on each side of the machine's central frame, and serve to transport the fruit from the platforms on which the operatives are located to a central conveyor belt. This central belt includes an inclined section disposed across the length of the machine and a vertical section for unloading the fruit into the bulk container.

In the machine of this patent, like in other existing machines, the fruit is conveyed to the bulk container by means of the aforementioned conveyor belts, which entails numerous drawbacks. One of said drawbacks stems from the fact that the fruit receive blows as they are conveyed along the belts, as they come into contact with each other, or rub against the sides of the belts, or as they jump from one belt to another. This translates into a reduction in the quality of the fruit, which is severely penalised by consumers.

Another drawback presented by the transport system based on conveyor belts, lies in the fact that it obliges the installation to have a high number of hydraulic or electric motors to move each of the machine's conveyor belts. Due to this, the machine is heavy, expensive and complex to manufacture and to maintain.

Patent application ES2393389 describes a fruit transport system that substantially improves the quality of handling of the harvested fruit. This system incorporates a plurality of carrier units for pieces of fruit, which each include a cup that is joined in a manner that can be tilted to a drag chain or cable. In the system claimed in said document, each piece of fruit may be transported individually in a cup that is kept in a horizontal position throughout the circuit, from the place of harvesting up to a bulk container which is associated to a structure of the frame of the machine.

This structure includes means for tilting the cups into an unloading position that allows the fruit to be deposited in the container.

The system claimed in this application presents the drawback that it is very slow as, in practice, the tilting movement of the cups is difficult to control, which has a negative effect causing numerous errors in the process of unloading the fruit. At the same time, it has been noted that the device for guiding and supporting the cups attached to the drag chain is very poor, entailing numerous mechanical problems related to misadjustment, breakage, etc...

### DESCRIPTION OF THE INVENTION

The object of the present invention is to resolve the drawbacks mentioned by developing a fruit and vegetable transport system that allows the pieces of fruit to be manipulated individually ensuring fast and controlled unloading of said pieces of fruit inside the bulk container.

In line with this objective, according to a first aspect, the present invention provides a fruit or vegetable transport system for a harvesting machine, which comprises a plurality of carrier units for depositing a piece of fruit or vegetable in each one, said system including means for dragging said plurality of carrier units, said dragging means configuring a conveyor circuit that includes at least one section for unloading said units into a container, and at least one section for loading the same units, once the fruit or vegetable has been deposited in said container, and is characterised in that said dragging means comprise a chain of links provided with means for integrally joining said carrier units to said chain, each link of said chain including an axis for a swivel joint with the adjacent link, the axis of two adjacent links of said chain determining a substantially right angle which allows the relative rotation of said adjacent links to orient said carrier units of fruit or vegetables in a predetermined manner in the space at a predetermined place in the circuit.

In the system of the present invention, the fruit or vegetable carrier units acquire an unloading position when actuated by the chain to which they are integrally joined, as the links of said chain acquire the appropriate orientation by means of the relative rotation of said links in respect of their hinge or swivel axis. In this way, as distinct from the systems in the state of the art, the fruit or vegetable can be unloaded rapidly, in a controlled manner, and in the required place, without the need for tilting carrier units.

On a separate note, the system of the present invention presents the advantage that it is very simple from a mechanical point of view, as the chain guide systems are made much simpler. Also, the disposition of the swivel axis of the adjacent links of the chain make it possible to change the direction of the chain itself and of the fruit or vegetable carrier units that are very difficult to obtain with other systems in the state of the art.

Preferably, said fruit or vegetable carrier units comprise a receptacle that is configured in such a way that it allows the piece of fruit or vegetable to be housed throughout a vertical section for unloading the carrier units, the fruit or vegetable being capable of being unloaded in said container when the links of the chain rotate and the change in orientation of said links causes the inversion of the receptacle of said carrier units.

Advantageously, said receptacle of the fruit or vegetable carrier units comprises a side wall with a substantially concave profile, said side wall extending from a base of the receptacle that is integrally joined to the links of the chain, the cavity of said concave wall being configured in such a way that it allows a piece of fruit or vegetable to be housed while said carrier unit is dragged by the chain throughout said vertical unloading section.

According to a preferred embodiment, said means for integrally joining said carrier units to the chain comprise a plurality of support studs which are provided in some links of the chain, said carrier units being capable of being fixed in a removably manner to said studs so as to be dragged by the chain.

Preferably, said support studs project from some links of the chain which are configured in the form of a conveyor carriage for said cups and, advantageously, said links which are configured in the form of a conveyor carriage each include a pair of projections to slide along a conveyor track, said projections being additionally configured in such a way that they are capable of engaging with a drive wheel of said chain.

In this way, the guiding and driving of the drag chain is simplified enormously, making the transport system safer and more efficient.

Advantageously, the system comprises at least one drive wheel disposed to engage with the projections of the links of said chain.

Preferably, said drive wheel is mounted on a frame structure of the harvesting machine which includes the section for unloading the fruit or vegetable carrier units.

Again advantageously, the section for unloading the fruit or vegetable carrier units includes a vertical conveyor track of said chain of links, said track being capable of being introduced inside the container to unload the fruit or vegetable.

Once again advantageously, the section for loading the fruit or vegetable carrier units includes a second conveyor track of said chain of links, said second track extending from one end of the unloading track to an arm of the frame of the machine which collects and transports the fruit or vegetable harvested by the operative.

According to a second aspect, the present invention provides a fruit or vegetable harvesting machine which comprises a frame provided with means for self-propulsion and controlled travel of the machine, and is characterised in that it includes the claimed transport system.

This harvesting machine makes it possible to harvest fruit very comfortably and quickly ensuring the quality of the handling at all times, as the pieces are unloaded into the container individually, when the change in orientation of the links causes the inversion of the position of the fruit or vegetable carrier units.

Preferably, said machine comprises a plurality of conveyor circuits for carrier units of fruit or vegetable pieces, each circuit including respective sections for loading and unloading said carrier units, each section for loading comprising a track for conveying the chain of links that extends from its respective unloading section to an arm for collecting and transporting the fruit or vegetable harvested by the operative.

Advantageously, said machine comprises a plurality of transport and collection arms which are each one of them associated to a section for loading fruit or vegetable carrier units, one end of each arms being joined in an articulated manner to a shaft of a structure of the frame which extends overhead above said loading section, said shaft acting as the centre of rotation of the arm to ensure that a piece of fruit is always tipped inside a carrier unit.

Again advantageously, said machine comprises a support structure for a plurality of sections for unloading fruit or vegetable carrier units, said structure being configured in such a way that it can be introduced inside the fruit or vegetable storage container in order to facilitate unloading of the pieces.

Preferably, said support structure for the unloading sections includes a plurality of drive wheels to engage with the projections of the respective links of the chain of said plurality of conveyor circuits for carrier units.

According to a third aspect, the present invention relates to a chain of links for dragging a plurality of fruit or vegetable piece carrier units, wherein each link of said chain includes an axis for the swivel joint of an adjacent link, the axis of two adjacent links of said chain determining a substantially right angle that allows the relative rotation of said adjacent links. The chain is characterised in the fact that it comprises means for integrally joining to said chain the fruit or vegetable carrier units, said chain being capable of orienting said fruit or vegetable carrier units in a predetermined manner in the space as said carrier units are dragged along the links of said chain.

Preferably, said chain comprises a plurality of support studs which are provided in some links of the chain, said carrier units being capable of being fixed in a removably manner to said studs so as to be able to be dragged by the chain.

Advantageously, said support studs project from some links of the chain that are configured in the form of a conveyor carriage for said cups.

Preferably, said links which are configured in the form of a conveyor carriage each include a pair of projections to slide along a conveyor track, said projections being additionally configured in such a way that they are capable of engaging with a drive wheel of said chain.

Once again preferably, the links of said chain are made of polymeric material and, advantageously, said material includes a mixture of polyamide and fibreglass. In this way, the chain is very resistant to wear.

### BRIEF DESCRIPTION OF THE DRAWINGS

For a better understanding of the description, a set of drawings is attached, where, schematically and by way only of a non-limiting example, a practical case of embodiment is represented. This embodiment is especially designed for the transport of fruit.

FIG. 1 is a schematic side view of a harvesting machine that includes the claimed transport system.

FIG. 2 shows a side view of a chain of links of the system of FIG. 1 and of a pair of fruit carrier units that are joined to said chain.

FIG. 3 shows a view in perspective of the chain of links of FIG. 2.

FIG. 4 shows a view in perspective of the system's chain of links which shows the different spatial orientation that the links can acquire.

FIG. 5 shows a schematic view in perspective of a structure of the frame of the machine which includes the sections for unloading fruit carrier units.

FIG. 6 shows a second schematic view in perspective of the structure of FIG. 5 which includes the sections for unloading fruit carrier units.

FIG. 7 shows a schematic side view of a vertical section for unloading associated to the structure of the frame and a drive wheel mounted on said structure which exerts traction on the chain.

FIG. 8 shows a schematic view of a fruit harvesting and transport arm disposed next to a conveyor track of a section for loading fruit carrier units.

### DESCRIPTION OF A PREFERRED EMBODIMENT

Next is a description of an embodiment of the system of the present invention with reference to the aforementioned drawings. This embodiment is especially designed for the transport of fruit and the fruit carrier units are configured by cups 2 for depositing a piece of fruit in each one of them.

The system 1 of the present invention includes a plurality of cup conveyor circuits 2 which are distributed over the frame 3 of a harvesting machine 4 which includes a plurality of arms 7 for transporting and collecting fruit.

Each one of the circuits includes a section 5 for loading the cups 2 and a section 6 for unloading the cups 2 into a container. The sections 5 for loading each circuit are each associated to an arm 7 for transporting and collecting the fruit harvested by an operative.

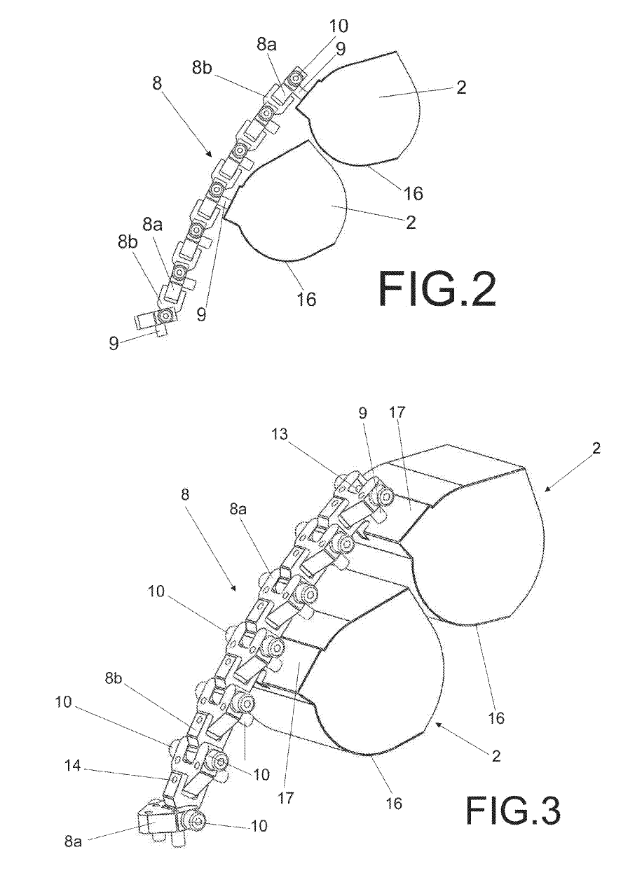

The cups 2 are dragged along said sections for loading 5 and unloading 6 of each circuit thanks to a chain 8 of links 8a which is provided with support studs 9 for the cups 2. As may be seen in detail from FIGS. 2 and 3, the cups 2 are joined integrally to the studs 9 which have been designed in such a way that they project from some links 8a which are configured in the form of a conveyor carriage for said cups 2.

The aforementioned links 8a each include a pair of projections 10 to slide along the length of a conveyor track 11 of the chain 8. Also, these same projections 10 are configured in such a way that they are capable of engaging with a drive wheel 12 of the chain 8.

As can be seen from FIGS. 2 to 4, each link 8a, 8b of the chain 8 includes an axis 13, 14 for the swivel joint of the hitch head of an adjacent link, the axis 13, 14 of every two adjacent axis 8a, 8b determining a substantially right angle (90°), which allows the relative rotation of said links 8a, 8b to provide a predetermined spatial orientation to the cups 2.

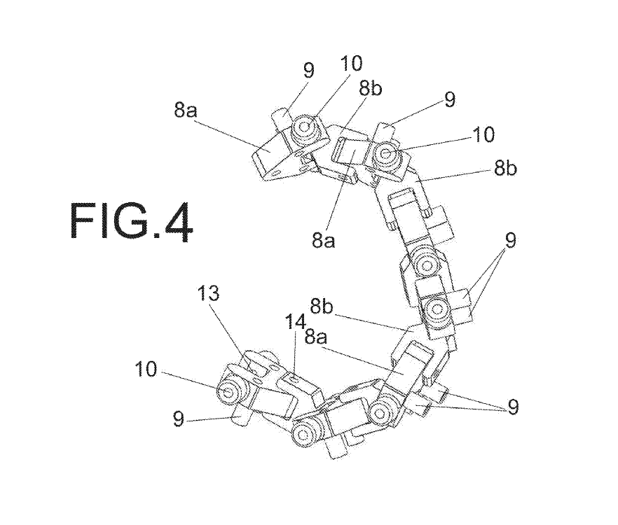

FIG. 4 shows a close-up of the different spatial orientations that the links 8a, 8b of the chain 8 can acquire thanks to their configuration and to the disposition of axis 13, 14 which articulate every two adjacent links. Thanks to this, the chain 8 allows changes in direction of the cups 2 which are impossible to obtain in the transport systems in the state of the art.

As already mentioned, in the present invention, as distinct from in the systems of the state of the art, the cups 2 acquire an unloading position when actuated by the chain 8, and the links 8a of the chain 8 which are joined to the cups acquire an spatial orientation that causes the cup 2 to invert.

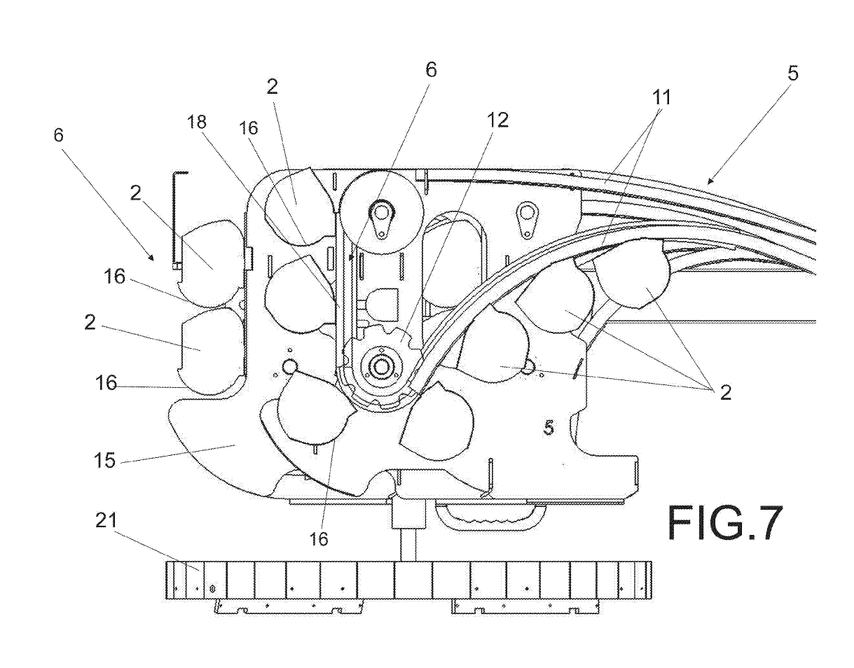

FIG. 7, shows a schematic side view of an unloading section 6 of the system 1, which is associated with a structure 15 of the frame 3 which is configured to be able to be introduced inside a storage container (not shown). In this figure, it can be appreciated how the cups 2 invert their position as the links 8a, 8b of the chain 8 rotate due to the dragging effect of the drive wheel 12 of the chain 8 which acts on the projections 10 of the links 8a.

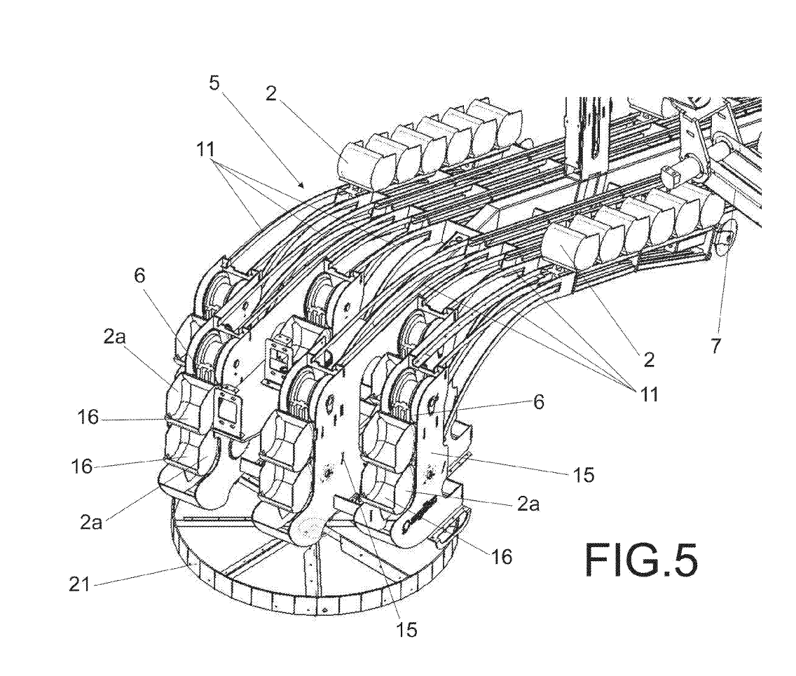

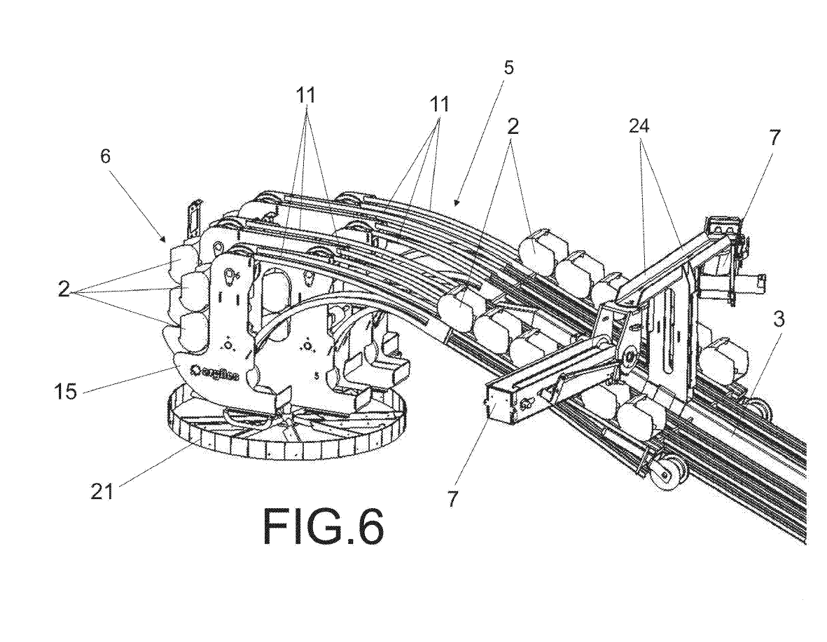

FIGS. 5 and 6 show respective schematic views in perspective of the structure 15 of the frame 3, which incorporates a plurality of sections 6 for unloading the cups 2 of different circuits. In the described embodiment, the aforementioned structure 15 incorporates six unloading 6 sections corresponding to six cup 2 conveyor circuits.

As can be seen from these drawings 5 and 6, the unloading sections 6 each include a track 18 for conveying the chain 8 which is vertically disposed. The cups 2 are conveyed vertically throughout said track 18 to the inside of the container where they unload the fruit on inversion of their position with the change in direction of the links 8a, 8b of the chain 8.

The cups 2 comprise a receptacle 2a which is configured with a concave wall 16 which extends from the base 17 defining a cavity for housing a piece of fruit while the cup 2 is dragged by the chain 8 along the vertical unload section 6. In this way, the pieces of fruit descend vertically into the inside of the container housed in the cups 2, and are unloaded inside the container as the position of the cup 2 is inverted when the orientation of the links 8a, 8b of the chain 8 changes (see FIG. 7).

Once the fruit has been unloaded, the cups 2 of each circuit are conveyed along a second conveyor track 11 of the chain 8. This second track 11 extends from the lower end of the unload track 18 up to an arm for transport and collection of the fruit harvested by the operative, configuring a loading section 5 of a circuit.

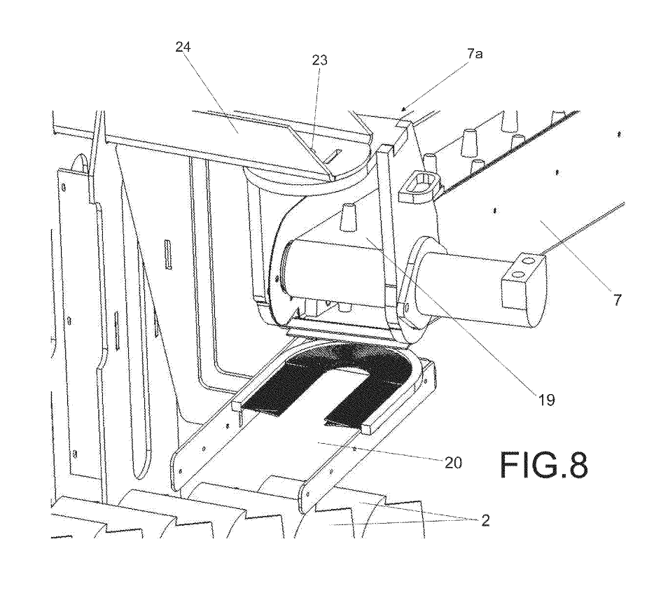

FIG. 8 shows a schematic view of a fruit collection and transport arm 7 disposed next to a conveyor track 11 of a section for loading cups 2. In this FIG. 8 it is possible to appreciate a fruit conveyor belt 19 of the arm 7 and a delivery platform 20 for sliding the fruit from said belt 19 to the cups 2. In FIG. 6, the loading sections 5 of two circuits with their respective cups 2 have been represented disposed next to respective arms 7 for transport and collection of fruit harvested by the operative.

As can be seen from these FIGS. 6 and 8, the end 7a of each arm 7 is joined in an articulated manner to a shaft 23 of a structure 24 of the frame that extends overhead above said loading section 5, said shaft 23 acting as the centre of rotation of the arm 7 to ensure that a piece of fruit always falls inside a cup 2.

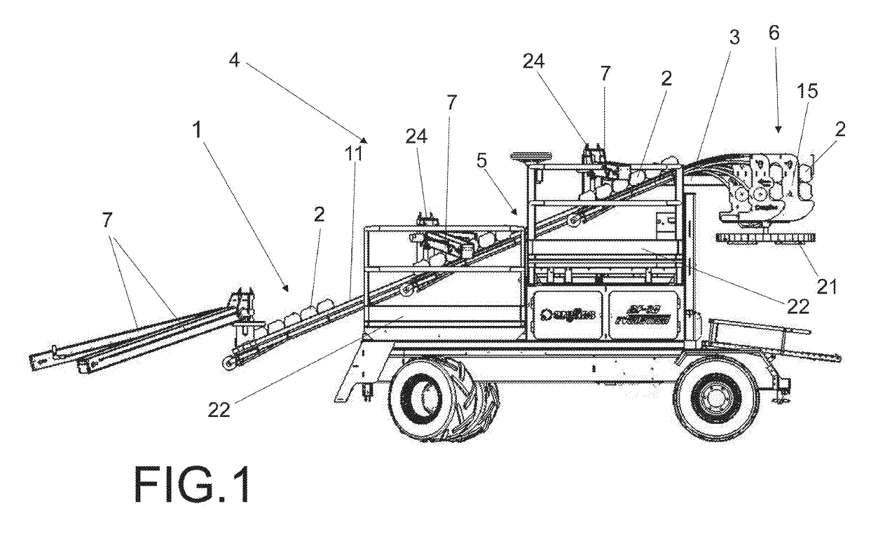

FIG. 1 shows a schematic side view of a harvesting machine 4 that incorporates the claimed transport system 1.

In this FIG. 1, it is possible to appreciate the disposition of the conveyor tracks 11 of the loading sections 5 of the cups 2 of different circuits which extend from the arms 7 for transport and collection of the fruit harvested by the operative. These arms 7 are joined in an articulated manner to the frame 3 of the machine 4 by means of structures 24 that extend overhead above cups 2 and are capable of rotation on their own axes 23 up to a working position in which they remain disposed at the height of the operative.

The same FIG. 1 shows the structure 15 of the frame 3 which supports the vertical unloading sections 6 of the different circuits. As may be seen from FIG. 1 this structure 15 is configured so as to be introduced inside a container and incorporates at its base a wheel 21 for distributing fruit that tips into the container (not shown).

In the described embodiment, conveyor tracks 11, 18 of the cups 2 are configured by two U-shaped profiles which are disposed opposite each other. The projections 10 of the links 8a of the chain 8 are inserted in each one of the profiles sliding inside as the chain 8 is dragged by the drive wheel 12 that acts on the same projections 10.

What follows is a description of the functioning of the harvesting machine 4 that incorporates the claimed transport system 1.

The machine 4 travels until situated between fruit trees. Then, the operatives are placed either on the ground, or on the platforms 22 that the machine 4 incorporates, always at the height of a fruit transport and collection arm 7.

While the machine 4 self-propels forward, the operatives collect fruit from the tree and carefully place it on the conveyor belt 19 of the arms 7 which leads it to the cups 2 of a loading section 5 of the transport system 1. The speed of the drag chain 8 of loading sections 5 of the cups 2 and the speed of the conveyor belt 19 which transports fruit from the arms 7 is programmed and synchronised in such a way that each cup 2 receives just one piece of fruit.

The cups 2 loaded with fruit are conveyed on the conveyor track 11 of loading section 5 of each circuit until reaching the corresponding vertical unloading section 6 situated on the rear part of the machine 4, on the support structure 15. At this point, the cups 2 travel vertically with the fruit housed in the cavity defined by the concave wall 16 of the receptacle 2a. As the links 8a, 8b of the chain rotate at the end of the unloading section 6, the orientation of said links 8a, 8b changes and the cups 2 are inverted to tip the fruit into the container (not shown).

With the claimed system 1, all fruit harvested by the operatives is led to and tipped into the container quickly and in a controlled manner, guaranteeing the quality of handling of the fruit at all times.

Despite the fact that reference has been made to a specific embodiment of the invention, it is obvious for a person skilled in the art that the described system is capable of numerous variations and modifications, and that all the aforementioned details can be substituted for others which are technically equivalent, without deviating from the scope of protection defined by the attached claims. For example, although reference has been made in the drawings to a system especially designed for transporting pieces of fruit, the same system could be used for transporting pieces of vegetables or other types of products that require careful handling.

1-16. (canceled)

17. A fruit or vegetable transport system for a harvesting machine, the system comprising:
a plurality of carrier units for depositing in each one a piece of fruit or vegetable, said system including a dragging device for dragging said plurality of carrier units, said dragging device determining a conveyor circuit that includes at least one section for unloading said units into a container, and at least one section for loading the same units once the fruit or vegetable has been deposited in said container; and
wherein said dragging device comprises a chain of links provided with members for integrally joining said carrier units to said chain, each link of said chain including an axis for a swivel joint with the adjacent link, the axis of two adjacent links of said chain determining a substantially right angle which allows the relative rotation of said links to orient said carrier units of fruit or vegetables in a predetermined manner in the space at a predetermined place in the circuit.

18. The system of claim 17, wherein said fruit or vegetable carrier units comprise a receptacle that is configured in such a way that it allows a piece of fruit or vegetable to be housed throughout a vertical section for unloading said carrier units, the fruit or vegetable being capable of being tipped inside said container when the links of the chain rotate and cause the inversion of the receptacle of said carrier units.

19. The system of claim 18, wherein said receptacle of the fruit or vegetable carrier units comprises a side wall having a substantially concave profile, said side wall extending from a base of the receptacle that is integrally joined to the links of the chain, the cavity of said concave wall being configured in a way that it can house a piece of fruit or vegetable while said carrier unit is dragged by the chain along said vertical unloading section.

20. The system of claim 17, wherein said support members for integrally joining said carrier units to the chain comprise a plurality of support studs which are provided in some links of the chain, said carrier units being capable of being fixed in a removably manner to said studs so as to be dragged by the chain.

21. The system of claim 20, wherein said support studs project from some links of the chain that are configured in the form of a conveyor carriage of said carrier units.

22. The system of claim 21, wherein said links which are configured in the form of a conveyor carriage each include a pair of projections for sliding along a conveyor track, said projections being additionally configured in such a way that they are capable of engaging with a drive wheel of said chain.

23. The system of claim 22, which comprises at least one drive wheel disposed to engage with the projections of the links of said chain.

24. The system of claim 23, wherein said drive wheel is mounted on a structure of the frame of the harvesting machine which includes an unloading section of the fruit or vegetable carrier units.

25. The system of claim 17, wherein the section for unloading the fruit or vegetable carrier units includes a vertically disposed conveyor track, said track being capable of being introduced inside the container to unload the fruit or vegetable.

26. The system of claim 23, wherein the section for loading the fruit or vegetable carrier units includes a second conveyor track of said chain of links, said second track extending from one end of the unloading track to an arm of the frame of the machine that collects and transports the fruit or vegetable harvested by the operative.

27. A fruit or vegetable harvesting machine comprising:
a frame provided with a device for self-propulsion and controlled travel of the machine, wherein said machine includes a transport system comprising:
a plurality of carrier units for depositing in each one a piece of fruit or vegetable;
a dragging device for dragging the plurality of carrier units, said dragging device determining a conveyor circuit that includes at least one section for unloading said units into a container, and at least one section for loading the same units, once the fruit or vegetable has been deposited in said container; and
wherein said dragging device comprise a chain of links provided with members for integrally joining said carrier units to said chain, each link of said chain including an axis for a swivel joint with the adjacent link, the axis of two adjacent links of said chain determining a substantially right angle which allows the relative rotation of said links to orient said carrier units of fruit or vegetables in a predetermined manner in the space at a predetermined place in the circuit.

28. The fruit or vegetable harvesting machine of claim 27, further comprising a plurality of conveyor circuits of fruit or vegetable carrier units, each circuit including respective loading and unloading sections of fruit or vegetable carrier units, each section for loading comprising a track for conveying said chain of links that extends from its respective unloading section to an arm for collecting and transporting the fruit or vegetable harvested by the operative.

29. The fruit or vegetable harvesting machine of claim 28, further comprising a plurality of arms for collection and transport of fruit each associated to a loading section of the system, one end of each one of said arms being joined in an articulated manner to a shaft of a structure of the frame which extends overhead above said loading section, said shaft acting as the center of rotation of the arm to ensure that a piece of fruit is always tipped inside a carrier unit.

30. The fruit or vegetable harvesting machine of claim 28, wherein the frame comprises a support structure for supporting the unloading sections of said plurality of conveyor circuits of fruit or vegetable carrier units, said structure being configured in such a way that it can be introduced inside the fruit or vegetable storage container in order to facilitate unloading of the pieces.

31. The fruit or vegetable harvesting machine of claim 30, wherein said support structure for the unloading sections includes a plurality of drive wheels to engage with the projections of the respective chains of links of the conveyor circuits of carrier units.

32. A chain of links for dragging a plurality of fruit or vegetable piece carrier units, wherein each link of said chain includes an axis for a swivel joint of an adjacent link, the axis of two adjacent links of said chain determining a substantially right angle that allows the relative rotation of said adjacent links, wherein said chain comprises:
a plurality of support members configured for integrally joining to the links of said chain the fruit or vegetable carrier units, said chain being capable of orienting said fruit or vegetable carrier units in a predetermined manner in the space as said carrier units are dragged along the links of said chain.

33. The chain of links of claim 32, wherein said support members comprise a plurality of support studs projecting from the links of the chain which are configured in the form of a conveyor carriage of said carrier units, and wherein said links configured in the form of conveyor carriage include a pair of projections for sliding along a conveyor track.
